(19) United States
(12) Patent Application Publication
(10) Pub. No.: US 2026/0092677 A1
(43) Pub. Date: Apr. 2, 2026

(54) UMBRELLA WARE SYSTEMS

(71) Applicant: Michael Hewett, Orondo, WA (US)

(72) Inventor: Michael Hewett, Orondo, WA (US)

(21) Appl. No.: 18/937,216

(22) Filed: Nov. 5, 2024

Related U.S. Application Data
(60) Provisional application No. 63/599,603, filed on Nov. 16, 2023.

(51) Int. Cl. F16M 13/02; A63F 1/10; A63F 3/00

(52) U.S. Cl. CPC F16M 13/022; A63F 1/10; A63F 3/00533; A63F 2003/00542

(57) ABSTRACT

The umbrella ware system allows for various system devices to be connected to and rotated manually around the pole while resting on the table surface. The system design allows for the installation and removal of system gaming boards, food service trays, and container holders without having to remove the pole. The devices can be rotated 360 degrees around the pole, counterclockwise or clockwise. The system features two (2) halves: one with a female connector design and one with a male connector design. The connectors may utilize permanent magnets to attract and hold the two halves together. The magnets are embedded in the male halves of the rectangular-shaped insertion pins as well as in the female halves of the rectangular-shaped receptacle cavities.

### CROSS-REFERENCE TO RELATED APPLICATION

The present application is related to and claims priority from prior provisional application Ser. No. 63/599,603, filed Nov. 16, 2023 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of tables and more specifically relates to accessories for tables and umbrella tables.

### 2. DESCRIPTION OF THE RELATED ART

Many people in modern society use furniture. Furniture may include for example, tables, chairs, desks, couches and the like. Certain furniture may be designed for outdoor use such as a table with an umbrella pole at the beach or the like. This furniture may be limited in its functionality.

Various attempts have been made to solve the above-mentioned problems such as those found in U.S. Pub. No. 2017/0294802 to Dee Volin. This art is representative of accessories for tables and umbrella tables. None of the above inventions and patents, taken either singly or in combination, is seen to describe the invention as claimed.

Ideally, an umbrella ware system should provide multifunctional use and, yet would operate reliably and be manufactured at a modest expense. Thus, a need exists for a reliable umbrella ware system to avoid the above-mentioned problems.

### BRIEF SUMMARY OF THE INVENTION

In view of the foregoing disadvantages inherent in the known accessories for tables and umbrella tables art, the present invention provides a novel umbrella ware system. The general purpose of the present invention, which will be described subsequently in greater detail is to provide multifunctional use for such tables.

The umbrella ware system is disclosed herein in various embodiments that allow for various system devices to be connected to and rotated manually around the pole while resting (or not) on the table surface provided. The system design allows for the installation (use of) and removal of system gaming boards, food service trays, and container holders without having to remove the pole. The devices can be rotated 360 degrees around the pole, counterclockwise or clockwise.

The preferred system features two (2) halves: one with a female connector design and one with a male connector design. The connectors may utilize permanent magnets to attract and hold the two halves together. The magnets are preferably embedded in the male halves of the rectangular, circular, or any required shape of insertion pins as well as in the female halves of the rectangular, circular or any required shape of receptacle cavities. This mechanical connection provides the strength required while rotating the connected devices around the pole.

Certain embodiments may find use as a game board caddy, a card game caddy, a condiment tray caddy and the like by way of example. Other applications are envisioned such as drink holders, container holders, food service tray holders and the like.

An umbrella ware system is disclosed herein, in a preferred embodiment, comprising: an umbrella ware assembly including a male member having a u-shape profile, and a female member; wherein the male member and the female member are configured via engagement for removable coupling about an umbrella pole. The female member is configured for holding at least one object. The umbrella ware system is rotatable about the umbrella pole, wherein the male member and the female member each comprise permanent magnets (or other suitable attachment means). The at least one object held via the female member may comprise a game board, playing cards, food, and alternately drink containers. Other objects may be held using the present invention.

A kit and method are also described herein.

The present invention holds significant improvements and serves as an umbrella ware system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, umbrella ware system, constructed and operative according to the teachings of the present invention.

FIG. 1 shows a top view illustrating an embodiment of an umbrella ware system according to an embodiment of the present invention.

FIG. 2 is a perspective view illustrating the umbrella ware system according to an embodiment of the present invention of FIG. 1.

FIG. 3 is a side view illustrating the umbrella ware system according to an embodiment of the present invention of FIG. 1.

FIG. 4 is a top view illustrating the umbrella ware system ready for coupling about an umbrella pole according to an embodiment of the present invention of FIG. 1.

FIG. 5 is a top perspective view illustrating the umbrella ware system ready for coupling about an umbrella pole according to an embodiment of the present invention of FIG. 1.

FIG. 6 shows a bottom perspective view illustrating an umbrella ware system according to an embodiment of the present invention.

FIG. 7 is a perspective view illustrating the umbrella ware system according to an embodiment of the present invention of FIG. 1.

FIG. 8 is a side view illustrating a hook magnet of the umbrella ware system according to an embodiment of the present invention.

FIG. 9 is a perspective view illustrating the hook magnet of the umbrella ware system according to an embodiment of the present invention of FIG. 8.

FIG. 10 is a top view illustrating a female condiments tray of the umbrella ware system according to an embodiment of the present invention.

FIG. 11 is a perspective view illustrating the female condiments tray and hook magnet of the umbrella ware system in relation to an umbrella pole for coupling thereto according to an embodiment of the present invention of FIG. 10.

FIG. 12 is a top view illustrating a male variable tray of the umbrella ware system according to an embodiment of the present invention.

FIG. 13 is a perspective view illustrating the male variable tray of the umbrella ware system according to an embodiment of the present invention of FIG. 12.

FIG. 14 is a perspective view illustrating the umbrella ware system in relation to the umbrella pole according to an embodiment of the present invention.

FIG. 15 is a perspective view illustrating an embodiment of the umbrella ware system.

FIG. 16 is a perspective view illustrating an embodiment of the umbrella ware system for use in holding playing cards.

FIG. 17 is a perspective view illustrating an embodiment of the umbrella ware system for use in holding objects such as condiments or the like.

FIG. 18 is a perspective view illustrating an embodiment of the umbrella ware system for use in holding objects such as beverage containers or the like.

FIG. 19 is a perspective view illustrating an embodiment of the umbrella ware system for use in holding a gameboard or the like.

The various embodiments of the present invention will hereinafter be described in conjunction with the appended drawings, wherein like designations denote like elements.

### DETAILED DESCRIPTION

As discussed above, embodiments of the present invention relate to accessories for tables and umbrella tables and more particularly to a umbrella ware system as used to improve the use and functionality of tables with umbrella poles.

Generally speaking, the present invention may have functionality and structure of a ‘lazy susan’ which provides a means of presenting food service trays or game boards in front of each individual sitting at either a rectangular or circular outdoor patio table as long as the umbrella pole is not in place. The lazy susan is able to travel through 360 degrees of travel for use in positioning food service trays, games or the like in front of individuals.

The present invention may also be modularly used having a female portion and a male portion. The connection means between them may comprise permanent magnets or other attachment means. The magnets may be embedded in the male portions in preferred embodiments. The female portions may have magnets or ferrous material such as steel or the like for use in communicative and removable attachment/coupling. The device may or may not alternately use wheels or bearings or the like. The device is able to be removably connected male to female about the umbrella pole for use. Plastic has been found to be a preferred material for use with many of the pieces of the present invention since it is cost-effective to manufacture, suitably durable and reasonably weather resistant; however other materials may be used.

Certain embodiments may find use as a game board caddy, a card game caddy, a condiment tray caddy and the like by way of example. Other applications are envisioned such as drink holders, container holder, food service tray holders and the like.

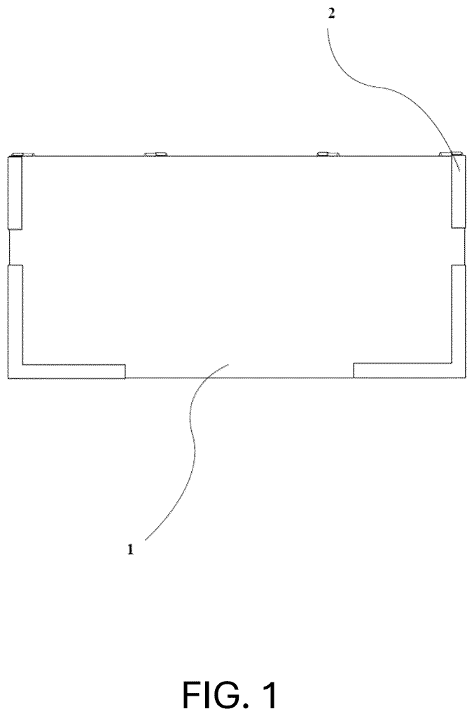

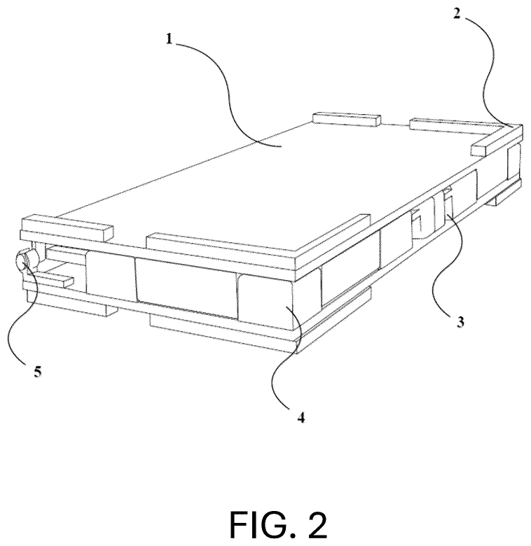

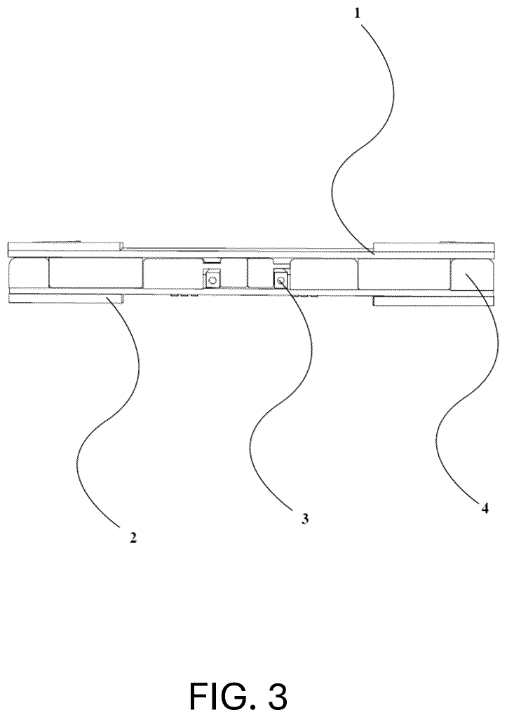

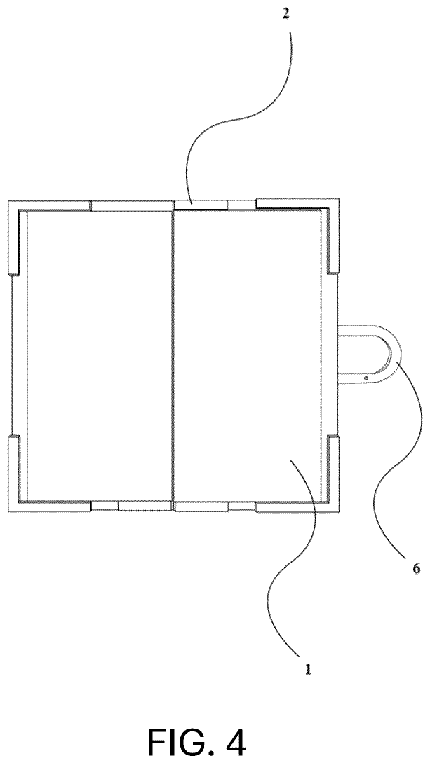

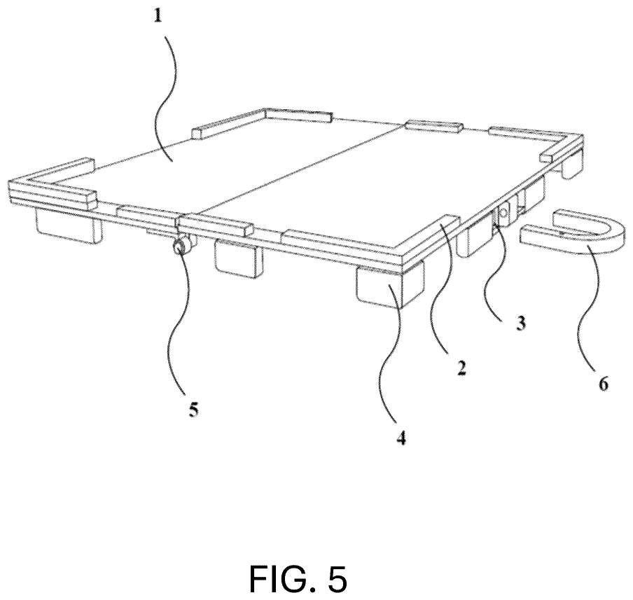

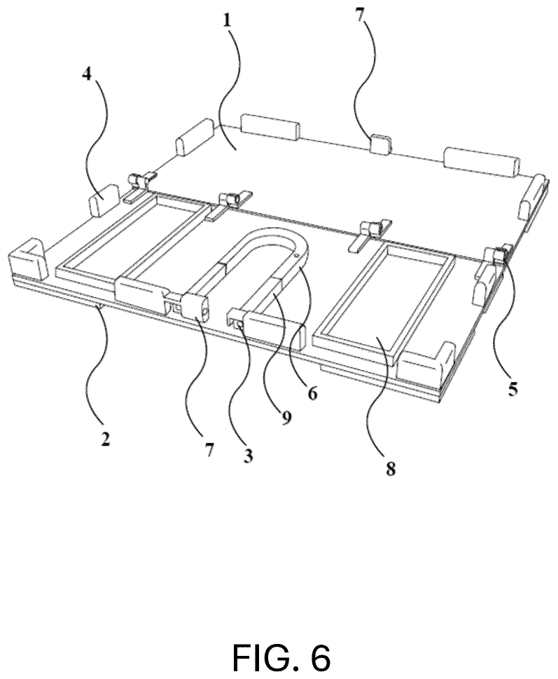

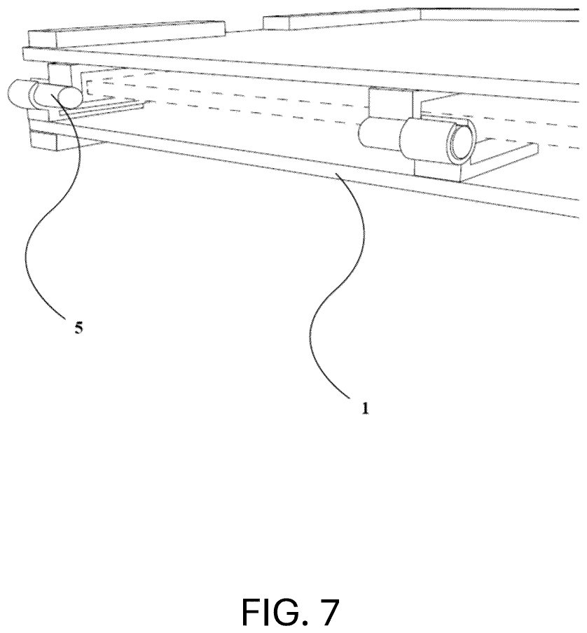

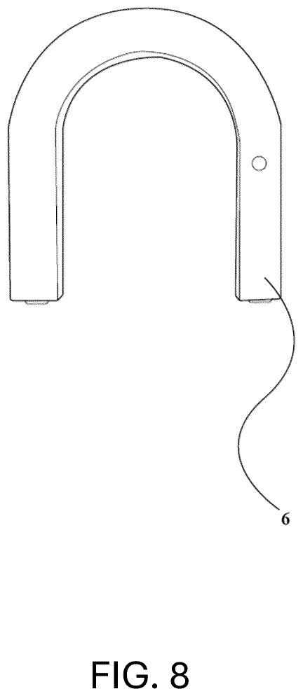

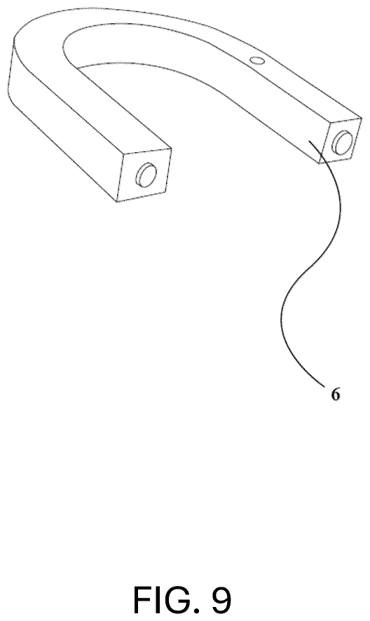

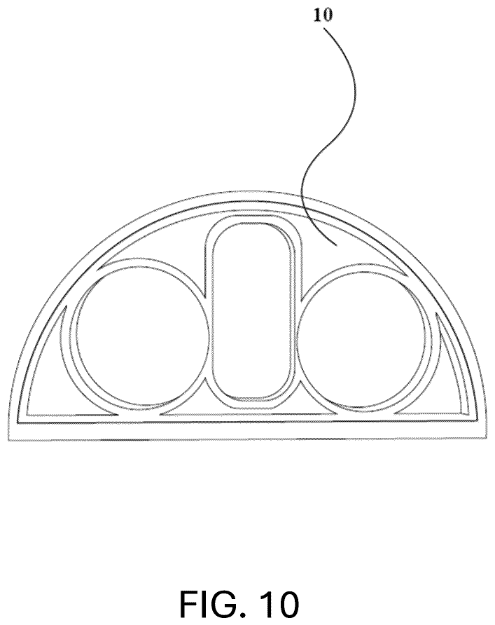

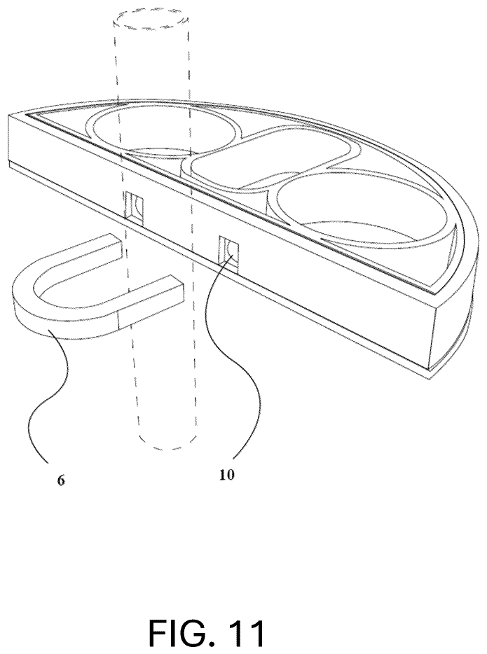

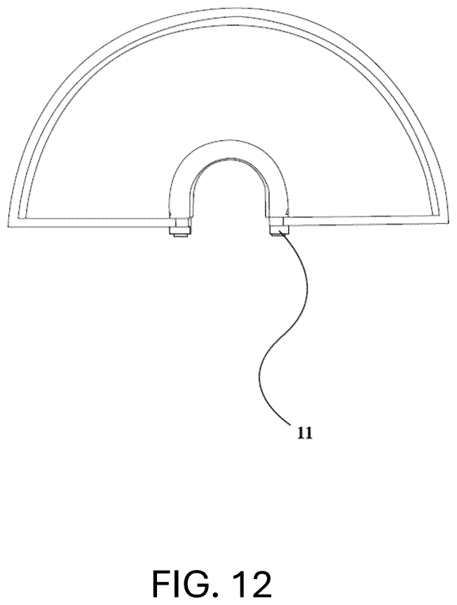

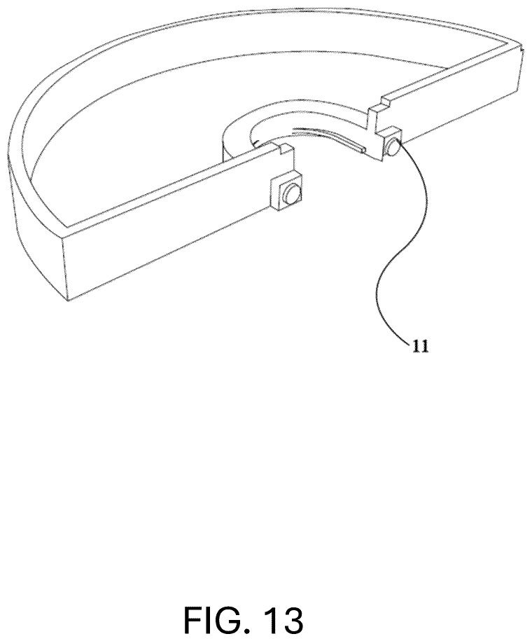

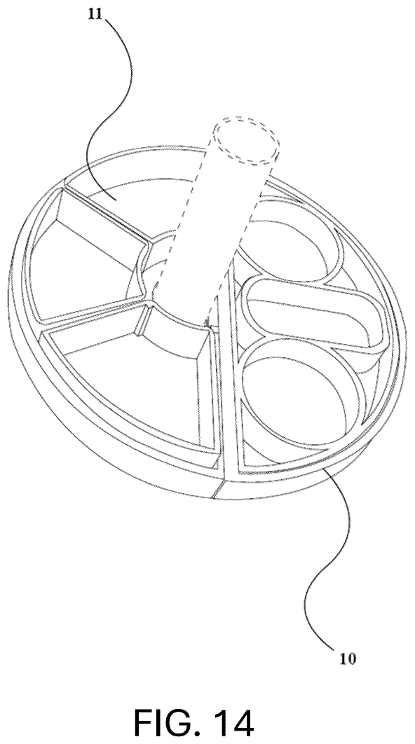

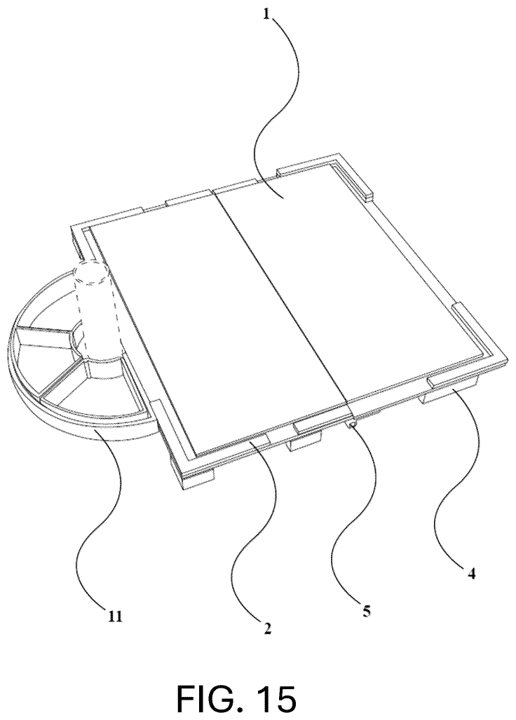

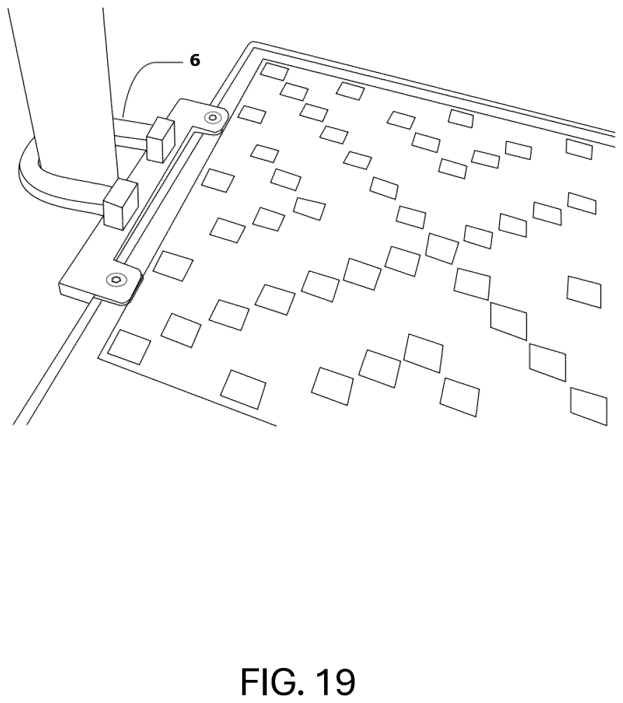

Referring to the drawings by numerals of reference there is shown in FIGS. 1-19, an umbrella ware system in a particular embodiment having at least the following components: bottom cover 1—forms the body of the umbrella ware; board edges 2—hold the board games; installed hook magnet 3—located in the main board. It allows it to connect to the male permanent magnet on the hook; fillet curved 4—for smooth sliding; hinges 5—split for snap in two (2) pieces; hook magnet 6—allows the umbrella ware to hook on to the patio table pole; folding lock magnet 7—locks the board when folded; letter holder storage 8—stores the holder for the letter tiles; stowed hook magnet 9—magnets that attach with the hook magnets; female condiments tray 10—holds condiments bottle(s); and male variable tray 11—used for other things that will make the game enjoyable.

The umbrella ware system includes: bottom cover 1 which forms the body of the umbrella ware; board edges 2 which hold the board games; installed hook magnet 3 which is located in the main board such that it allows connection to the male permanent magnet on the hook; fillet curved 4 which is for smooth sliding; hinges 5 which are split for snap in 2 (two) pieces; hook magnet 6 that allows the umbrella ware to hook on to the patio table pole; folding lock magnet 7 which lock the board when folded; letter holder storage 8 that stores the holder for the letter tiles; stowed hook magnet 9 comprises magnets that attach with the hook magnets; female condiments tray 10 which holds condiments bottle; and male variable tray 11 may be used for other things that will make the game enjoyable.

The umbrella ware system allows for various system devices to be connected to and rotated manually around the pole while resting on (or above) the table surface. The system design allows for the installation and removal of system gaming boards, food service trays, and container holders without having to remove the pole. The devices can be rotated 360 degrees around the pole, counterclockwise or clockwise. The system features two (2) halves: one with a female connector design and one with a male connector design. The connectors preferably utilize permanent magnets to attract and hold the two halves together. The magnets are embedded in the male halves of the rectangular, circular, or any required shape of insertion pins as well as in the female halves of the rectangular, circular or any required shape of receptacle cavities. This mechanical connection provides the strength required while rotating the connected devices around the pole.

As designed, the halves can easily be separated with modest force. The male halves of the system provide the hooking mechanism for typical umbrella pole diameters (preferably 1.5 in.+/−0.25 in. nominal diameter). This half can be as simple as a U-shaped hook or a utility-sized circular or rectangular tray of various sizes for game parts, food, and drink holders. The female halves can also be of various sizes and shapes for carrying gaming boards and gaming components, as well as food service trays and container holders. The male and female halves are not required to be of matching dimensions except at the connector.

The umbrella ware system comprises: an umbrella ware assembly including a male member having a substantially u-shape profile, and a female member; wherein the male member and the female member are configured via engagement for removable coupling about an umbrella pole. The female member is configured for holding at least one object, and as designed the umbrella ware system is rotatable (manually) about the umbrella pole. The male member preferably comprises permanent magnets and in alternate embodiments the male member does not comprise permanent magnets. The female member may comprise permanent magnets and alternately the female member may comprise ferrous material. The male and female member may be removably attached via suitably equivalent means via fasteners, hooks, clips, hook and loop, and the like.

In certain embodiments the female member comprises a clamp; the clamp is configured to couple to a game board. The clamp may comprise clamping means, biasing means, or simply attaching means such as fasteners or the like. Upon reading this specification, it should be appreciated that, under appropriate circumstances, considering such issues as user preferences, design preference, structural requirements, marketing preferences, cost, available materials, technological advances, etc., other coupling and connecting arrangements such as, for example, clips, snaps, various fasteners, etc., may be sufficient. Further, those with understanding in the art of magnets will understand the coupling means available and suitable equivalents.

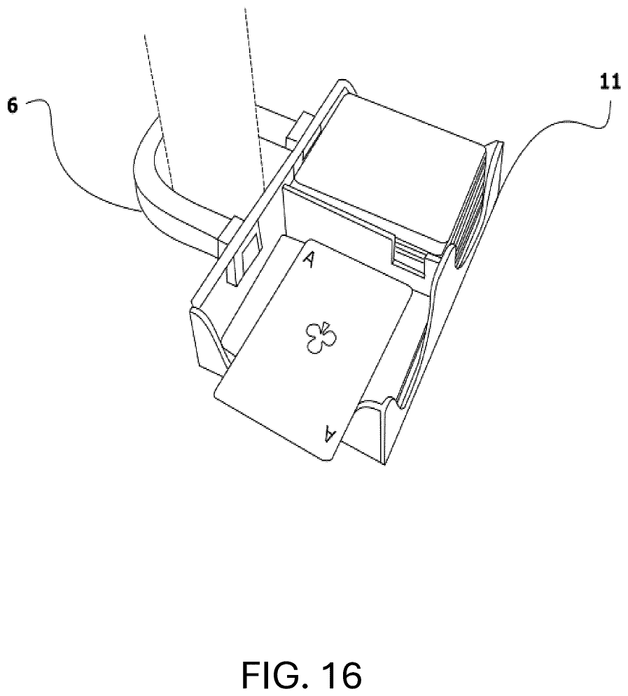

In certain embodiments the female member comprises at least one negative volume(s) partially enclosed via walls and in those embodiments the walls do not comprise a top wall such that playing cards or the like are readily accessible as shown in FIG. 16. In these embodiments the at least one negative volume comprises exactly two of the negative volume(s) such that it can hold at least one deck or more of cards. The exactly two of the negative volume(s), as mentioned, are configured and sized to fit playing cards therein. The walls may comprise ‘hand-engageable-cutouts’; the ‘hand-engageable-cutouts’ comprising openings suitable for users to readily access the playing cards. Further, the cutouts may comprise means for holding the cards in an elevated positioning and such that the cards may be placed perpendicular to the cards underneath.

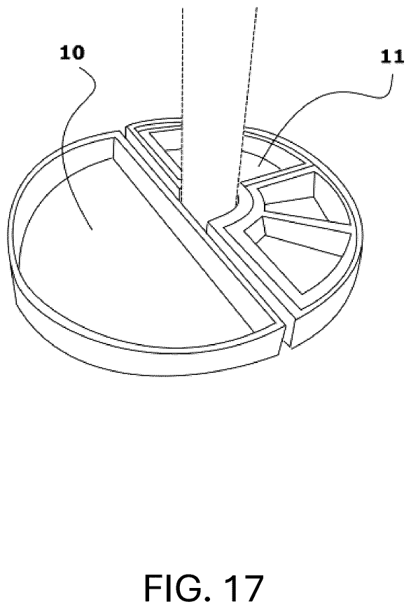

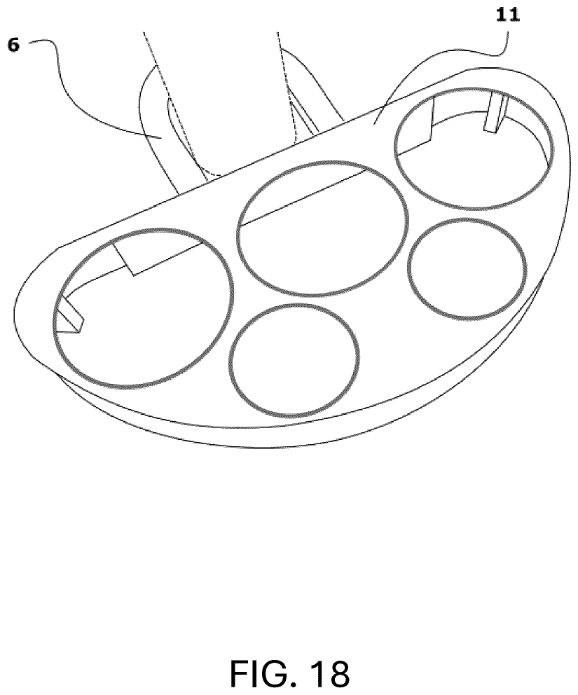

In alternate embodiments the female member comprises a top-member and a bottom-member; the top-member is substantially planar and comprises apertures and the bottom-member is substantially planar and does not comprise apertures, as shown in FIG. 18. This provides means whereby objects such as containers like beverage cups may be held, removed and returned. Other embodiments may have walls suitable for holding food items such as sauces and the like, as shown in FIG. 17.

A kit for the umbrella ware system may comprise the following parts: at least one game board; at least one set of playing cards; and at least one set of user instructions. The kit has instructions such that functional relationships are detailed in relation to the structure of the invention (such that the invention can be used, maintained, or the like in a preferred manner). The umbrella ware system may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

A method of using an umbrella ware system may comprise the steps of: providing the umbrella ware system comprising an umbrella ware assembly, engaging the umbrella ware assembly about an umbrella pole, and engaging with at least one object; wherein the engaging the umbrella ware assembly about an umbrella pole step is via magnetic means and may further comprise the step of uncoupling the umbrella ware assembly from the umbrella pole after use is complete.

It should be noted that the steps described in the method of use can be carried out in many different orders according to user preference. The use of “step of” should not be interpreted as “step for”, in the claims herein and is not intended to invoke the provisions of 35 U.S.C. § 112, ¶ 6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An umbrella ware system comprising:
an umbrella ware assembly including
a male member having a u-shape profile; and
a female member;
wherein said male member and said female member are configured via engagement for removable coupling about an umbrella pole;
wherein said female member is configured for holding at least one object; and
wherein said umbrella ware system is rotatable about said umbrella pole.

2. The umbrella ware system of claim 1 wherein said male member comprises permanent magnets.

3. The umbrella ware system of claim 1 wherein said male member does not comprise permanent magnets.

4. The umbrella ware system of claim 1 wherein said female member comprises permanent magnets.

5. The umbrella ware system of claim 1 wherein said female member comprises ferrous material.

6. The umbrella ware system of claim 1 wherein said female member comprises a clamp.

7. The umbrella ware system of claim 6 wherein said clamp is configured to couple to a game board.

8. The umbrella ware system of claim 1 wherein said female member comprises at least one negative volume(s) partially enclosed via walls.

9. The umbrella ware system of claim 8 wherein said walls do not comprise a top wall.

10. The umbrella ware system of claim 9 wherein said at least one negative volume comprises exactly two of said negative volume(s).

11. The umbrella ware system of claim 10 wherein said exactly two of said negative volume(s) are configured and sized to fit playing cards therein.

12. The umbrella ware system of claim 11 wherein said walls comprise hand-engageable-cutouts.

13. The umbrella ware system of claim 1 wherein said female member comprises a top-member.

14. The umbrella ware system of claim 13 wherein said female member further comprises a bottom-member.

15. The umbrella ware system of claim 14 wherein said top-member is substantially planar and comprises apertures.

16. The umbrella ware system of claim 15 wherein said bottom-member is substantially planar and does not comprise apertures.

17. An umbrella ware system comprising:
an umbrella ware assembly including
a male member having a u-shape profile; and
a female member;
wherein said male member and said female member are configured via engagement for removable coupling about an umbrella pole;
wherein said female member is configured for holding at least one object;
wherein said umbrella ware system is rotatable about said umbrella pole;
wherein said male member comprises permanent magnets;
wherein said female member comprises permanent magnets; and
wherein said at least one object held via said female member comprises a game board, playing cards, food, and alternately drink containers.

18. The umbrella ware system of claim 17 further comprising a kit including:
said game board,
said playing cards; and
instructions for use and play.

19. A method of using an umbrella ware system comprising the steps of:
providing said umbrella ware system comprising an umbrella ware assembly;
engaging said umbrella ware assembly about an umbrella pole; and
engaging with at least one object.

20. The method of claim 19 wherein said engaging said umbrella ware assembly about an umbrella pole step is via magnetic means and further comprising the step of uncoupling said umbrella ware assembly from said umbrella pole after use is complete.
